(19) United States
(12) Patent Application Publication
(10) Pub. No.: US 2009/0227475 A1
(43) Pub. Date: Sep. 10, 2009

(54) IMAGERY DEVICE FOR BIOCHIP AND ASSOCIATED BIOCHIP

(75) Inventors: Jean-Luc Reverchon, Paris (FR); Giovanni Mazzeo, Rome (IT)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/092,756

(22) PCT Filed: Nov. 8, 2006
(86) PCT No.: PCT/EP06/68238

§ 371 Date: Sep. 17, 2008

(30) Foreign Application Priority Data
Nov. 8, 2005 (FR) 05 11346

(51) Int. Cl. C40B 60/12

(52) U.S. Cl. 506/39

(57) ABSTRACT

An imagery system for a biochip (10) which comprises an approximately plane support, and a plurality of spots on an upper face (11), on which biochemical elements (12) are arranged, comprises a source (20) of a light beam to illuminate said upper face of the biochip and a device (30) for detecting radiation emitted by said upper face. The source and/or the detection device have good selectivity at at least one wavelength of interest (λᵢ) within an ultraviolet radiation band. The biochip support has a reflectivity or transmission coefficient at said wavelength of interest for which the lower limit is of the order of 10 percent.

### CROSS-REFERENCE TO RELATED APPLICATIONS

The present Application is based on International Application No. PCT/EP2006/068238, filed on Nov. 8, 2006, which in turn corresponds to French Application No. 05 11346, filed on Nov. 8, 2005, and priority is hereby claimed under 35 USC §119 based on these applications. Each of these applications are hereby incorporated by reference in their entirety into the present application.

### FILED OF THE INVENTION

The domain of the invention is biochips such as DNA or protein chips, or immunological sensors and associated imagery devices.

### BACKGROUND OF THE INVENTION

Biochips are biochemical tools for massive collection of information on nucleic acids (DNA chips) and amino acids (protein chips), antigens and antibodies (immunological sensors). When associated with techniques for digital processing of collected information, DNA chips can be used to carry out research (detection, separation, identification, study) to access DNA directly. Protein chips are capable of detecting, identifying, separating, studying proteins and determining their activities, functions, interactions, modifications with time, etc. Immunological sensors based on a link with an enzyme will be used to detect antibodies/antigens.

Therefore in general, the invention relates to biochips which are in the form of a solid support on the surface of which biochemical elements are immobilised. The position of each spot of biochemical elements is known, and its composition may also be known. For example in the case of a DNA chip, biochemical elements may for example be known specific oligonucleotides (single strands). Their role is to detect marked complementary targets present in the complex mix to be analysed. The detection principle used in DNA chips is based on possibilities of matching DNA strands with their complementary bases.

Remember that DNA and RNA have a spiral shape comprising two chains of complementary and antiparallel nucleotides. DNA or RNA nucleotide chains are characterised by four nitrogen bases, that confer capital properties on biological compounds. For DNA, the four bases are adenine A, cytosine C, guanine G and thymine T. For RNA, uracile replaces thymine, while the other three bases are common to DNA. These bases are complementary in pairs; A pairs with T or U, and G pairs with C. This capacity of single strands of DNA or monocatenary DNA to form a double spiral by pairing of complementary bases is used in the principle of detection by DNA chips. This is hybridising; biochip probes are put into contact with the sample to be analysed. If the sample comprises the complementary sequence of a probe, it attaches itself to this probe. The result is a hybridised chip. The next step is to detect and quantify all targets searched for in the mix to be analysed, by analysing the hybridised chip. Protein chips and immunological sensors operate on a similar principle, the first ones to detect chains of amino acids, while the others are used to detect antibodies/antigens.

In practice, a biochip comprises a very large number of spots in an ordered matrix arrangement. Probes are either grafted onto the support or synthesised in situ (hybridising unit=spot). The high density of spots enables parallel detection of thousands of sequences. The biochip technology can thus cover the genome (DNA chips) or proteome (protein chip) of an organism with a single chip.

The solid support is typically a glass slide with a size comparable to a microscope slide. There are also silicon and nylon supports. A spot is the chip hybridising unit. Considering the example of a DNA chip, DNA fragments that form a specific probe are deposited on each spot of this chip. In one example, there may be spots of the order of 100 μm and 1000 to 10000 spots per cm². These are all probes useful for hybridising complementary DNA sequences from a biological sample to be analysed. The position and composition of the sequence on each probe (and each spot) is known. It is said that the chip is functionalised to detect particular targets.

In practice, this probe is put into contact with the complex mix to be analysed, which may be in solution, or on a solid substrate so as to enable pairing by complementary base. The next step is to wash the chip to eliminate what is not paired. The result is a hybridised chip that has to be analysed.

Imagery devices are used for this purpose, so as to produce a map of the biochip.

In the state of the art, radioactive or fluorescent types of markers are usually used and are added to samples to confer emitting properties to them that are then used for the detection of chains by measuring the corresponding radioemissive or fluorescent signal. The images obtained are digitised and then processed by specific processing algorithms for these data, used by data processing means.

One frequently used marking system consists of physicochemical marking by fluorescent markers, in other words chromophoric compounds. These systems are widely used because they provide good detection sensitivity.

In the physicochemical marking protocol, sample strands are marked by chromophoric compounds, usually cyanine 3 or 5. The next step is to compare marking of an unknown target with marking of a reference target using a different marker for each of them. An image corresponding to each chromophoric compound has to be acquired to generate a complete image of the hybridised chip. The intensity of the fluorescent signal emitted on the different spots is measured in each spectral band. For example, this can be done using a scanner. Scanners suitable for this use are available off-the-shelf. As a reminder, the detection principle is then to place the chip in a black chamber; the scanner illuminates the slide by means of a high power laser beam. Due to the fluorescence effect, a beam is emitted in a different spectral band depending on the marker, at the location of the different spots on which the strands are paired, and the scanner detects the beam. An image analysis extracts hybridising signals from each probe. The images are obtained in digital form. Data processing of these images is then used to identify and quantity analytes in the analysed mix, to compare the results obtained with the results of known samples. Signal measurements can be refined by background noise elimination techniques, particularly auto-fluorescence of the support. This technique according to the state of the art gives very good detection sensitivity necessary for the entire range of DNA chip applications.

Thus, the DNA chip hybridising technique is closely combined with the fluorescent or radioactive marking technique to the extent that it is indissociable, which is clear in many publications.

Thus, the bioinfo-biotechnologies glossary, accessed on Oct. 27, 2005 from the home page of Infobiogen © at the Centre National of Ressources Informatiques Appliquees to the Génétique (National Centre of Data Processing Resources Applied to Genetics) (http://www.infobiogen.fr), gives a definition for DNA chip in an article title “Puce à AND Biopuce-Matrix” (“DNA chip—Biochip—matrix”), which can be translated as follows: “Hybridising technique enabling a comparative genomic analysis of the expression of a large number of mRNA patterns. Oligonucleotides (simple strands) immobilised on a solid support (matrix), specific to different known genes or cDNA, form probes, the role of which is to detect complementary marked targets present in the complex mix to be analysed (mRNA extracted from cells, tissues or entire organisms and converted into cDNA). The probes are either grafted onto the support or synthesised in situ (hybridising unit=spot). The hybridising signals are detected by X-ray measurement or by fluorescence depending on the marking type, radioactivity or fluorescence, and are quantified”. The Institut Pasteur site (http://www.pasteur.fr) on the same date also contained a file entitled “La génomique à l'Institue Pasteur” (“Genomics at the Institut Pasteur”), describing biochips. There we can read (translation) “These tools, for which the concept dates from the end of the 1980s, are used to simultaneously search for the presence of thousands of genes (or products of given genes (mRNA)) in a solution containing unknown DNA (or RNA) sequences. To achieve this, thousands of different molecular “hooks” (probes) are fixed onto a support, each hook being specific to a searched gene (or mRNA). This support is brought into contact with a solution containing the sequences to be analysed, marked by fluorescence. If a gene (or mRNA) is in contact with a probe specific to it, it will be fixed to it. Otherwise, it will remain “free” and will be evacuated by rinsing. Finally, fluorescent spots on the support will indicate which probes have fixed their specific gene (or mRNA) and therefore which genes (or mRNA) searched for were present in the analysed sample.”

However, there are many disadvantages with this technique. It makes the chip hybridising process more complex, imposing additional expensive and sensitive steps to perform the marking. The chromophores used as markers are expensive compounds and their life is short. They introduce incorporation and reading bias due to the presence of several markers per spot, or due to deterioration of the physicochemical properties of strands due to markers. They are subject to aging phenomena, particularly under the effect of illumination.

An attempt was made to find a direct detection device in the invention, in other words a device that does not require the use of markers but which uses the intrinsic optical properties of the detected elements, in other words the absorption characteristics of ultraviolet radiation. The wavelengths may be more particularly attractive, depending on the type of biochip. For example, the main interest for DNA chips will be absorption characteristics at 260 nm, while for protein chips it will be at 280 nm.

Electrophoresis techniques, particularly capillary electrophoresis, use these optical properties, particularly to analyse the purity of nucleic acids. Capillary electrophoresis uses a molten silica capillary, which has the property of being transparent at 260 nanometres, the two ends of the capillary forming an anode and a cathode. The capillary is full of an electrophoresis gel in which the sample to be analysed is injected at the end of the cathode. A migration of molecules towards the anode is obtained under the effect of an electric field obtained by applying an electric voltage between the anode and the cathode. The effective mobility of molecules decreases when the charge/mass ratio decreases. The support (gel) does not play any electrical part. However, its porosity controls the molecule migration velocity as a function of their size, for equal charges. This property provides a means of determining the size of DNA fragments contained in a mix to be analysed after calibration of a size scale for a determined electrophoresis support, using fragments of a known size. An associated imagery system, for example containing a CCD sensor, will be used to measure UV absorption by the different molecules directly on the capillary, using a transmissive detection system; the ultraviolet radiation source is at the capillary end, and there is a CCD sensor that recovers the image of the absorption contrast at the other end.

Electrophoresis techniques and techniques associated with biochips do not cover the same applications, such that they are not equivalent. Furthermore, electrophoresis techniques also use marking techniques, for example by fluorescence, or amplification techniques, for example when the objective is to distinguish between fragments of the same size that have the same migration in the capillary.

The purpose of the invention is to use the optical UV absorption properties to detect targets on hybridised biochips.

The main problem with the use of these optical ultraviolet absorption properties is related to the possibility of obtaining sufficient contrast, particularly with regard to the support.

In the electrophoresis context, the optical path of ultraviolet radiation is sufficiently large to obtain a sufficient absorption contrast, enabling detection with good sensitivity. Furthermore, these DNA fragments are much longer in these techniques. In biochips, we use chains of nucleotide acids that may comprise fewer than 100 bases. In electrophoresis, this number varies from about a hundred to several hundred thousand. The dimensions of the capillary are usually between 50 and 100 micrometers for the inside diameter. The optical path through the capillary in DNA fragments is increased by the use of means such as Z-shaped cells or bubble-shaped cells, up to a few millimetres.

One purpose of the invention is to enable the use of detection by UV absorption contrast in the DNA chip, and more generally in a biochip, to obtain an imagery system by direct detection that is sufficiently sensitive but is less expensive than systems using marking techniques.

In practice, the detection sensitivity is related to the possibility of developing a contrast. Firstly the biochip support has to be considered, and secondly the dimensions of biochemical elements (of the probe, or of the probe hybridised with a target) that are fixed on spots.

The support is the source of a detection background noise. Biochemical elements on the biochip are short; they may include less than 100 bases and usually less than 5000 bases. They are fixed on the support in thin layers, finer than about a hundred nanometres. This is far from the optical paths of a few millimetres obtained in electrophoresis that are used to develop a sufficient contrast.

However, the applicant has demonstrated that, quite unexpectedly and despite the small dimensions of biochemical elements to be detected on the chips, good sensitivity is obtained with a direct detection system using light and/or a detector specific to the spectral range of the radiation to be detected, combined with a support capable of enhancing the contrast. In this way, any additional step related to marking is eliminated. The associated costs are eliminated.

### SUMMARY OF THE INVENTION

Therefore, the invention relates to a biochip imagery system, the biochip comprising an approximately plane support with a plurality of spots on the upper face, on which biochemical elements are arranged, said system comprising a light beam source to illuminate said upper face of the biochip and a device for detection of radiation emitted by said upper face, characterised in that said source and/or said detection device have good selectivity at at least one wavelength of interest within an ultraviolet radiation band, and in that said support has a reflectivity or transmission coefficient at said wavelength of interest for which the lower limit is of the order of 10 percent.

Advantageously, the selective radiation detector is a semiconducting device with selective response at the wavelength of interest. It may be an active layer that gives a response from the length of interest and illuminated through a window layer filtering shorter wavelengths. Such a detector enables the use of an off-the-shelf white source as the biochip illumination source.

According to one improvement of the invention, the upper face of the biochip comprises patterns on which spots are arranged, said patterns being such that the optical path of the light beam through the biochemical elements is increased.

The invention also relates to a biochip comprising a support with such patterns. A biochip with this characteristic could improve the response of the imagery system.

According to a first embodiment, these patterns are protuberant geometric patterns such that the density of biochemical elements on each spot is increased.

According to a second embodiment, these patterns are porosities, the support comprising at least three layers, a first porous layer for which the porosities form spots on which biochemical elements are immobilised, and a layer on each side, at least one of which is porous, said layers on each side having a reflecting face towards said first porous layer, such that the optical path is enhanced by the reflection effect in this porous layer.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 shows a first example embodiment of an imagery device by direct detection of absorption contrast according to the invention;

FIG. 2 shows a second embodiment of an imagery device according to the invention, enabling a multi-spectral analysis;

FIG. 3 shows another example embodiment of an imagery device according to the invention, operating on the transmission mode;

FIG. 4 shows the spectral properties of a chip support used in an imagery device according to the invention,

FIG. 5 shows the spectral responses of a detector with an active layer on the filtering window layer;

FIG. 6 is a diagram of an implementation of an imagery device according to the invention with spectral filtering of the source using a spectroscope;

FIGS. 7a to 7f show images obtained with an imagery device according to the invention, used with a DNA chip;

FIGS. 8a to 8d show example embodiments of an improved chip support, capable of improving the sensitivity of an imagery device according to the invention;

FIGS. 9 and 10 show a variant of an imagery system according to the invention used to exploit polarisation of light;

FIG. 11 shows a slide support with gratings facilitating polarisation;

FIG. 12 shows a variant of the systems in FIGS. 9 and 10; and

FIG. 13 shows the different states of polarisation of light before and after reflections on a surface.

### DETAILED DESCRIPTION OF THE DRAWINGS

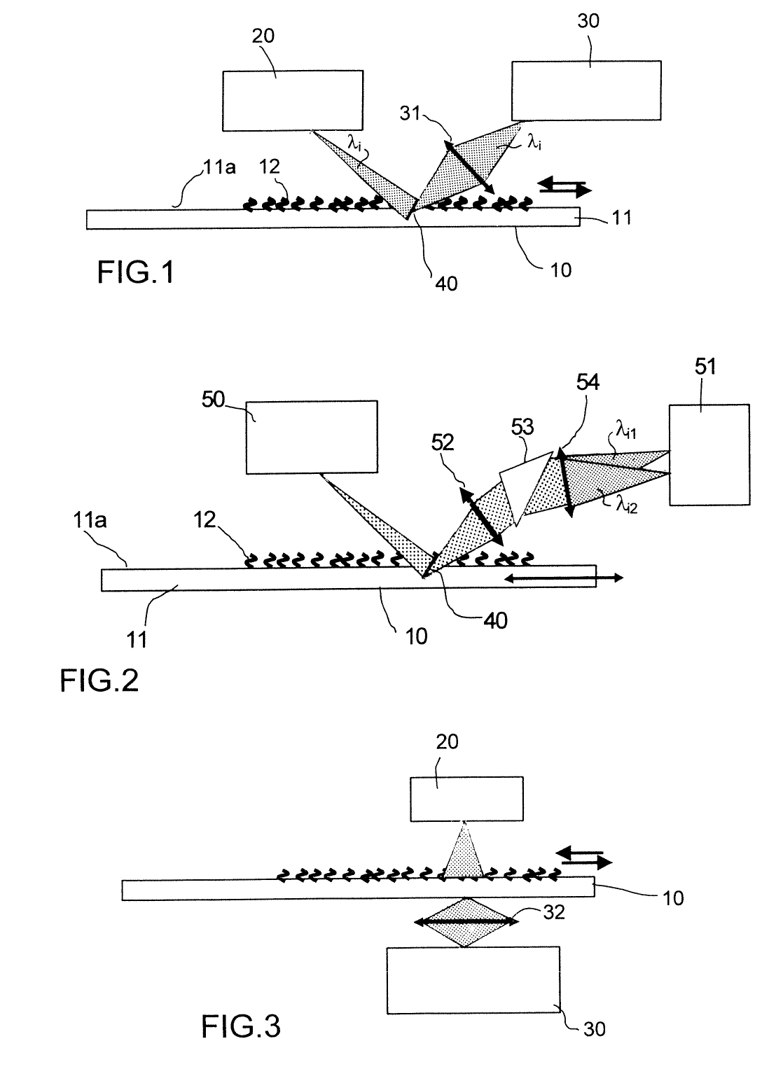

An imagery device by direct detection of an absorption contrast according to the invention comprises the following, as shown in FIG. 1:

a biochip 10 comprising mainly a plane support 11, typically a slide, comprising a plurality of spots on its upper face 11a, on which biochemical elements 12 are immobilised. In practice, the slide of a DNA chip is about ten centimetres long and a few centimetres wide.

an illumination source 20 supplying a light beam with a wavelength of interest λᵢ, with an optic focusing this beam on the top face of the biochip, along a focusing axis 40.

a semiconductor detection device 30 sensitive to at least one wavelength of interest λᵢ and an optic 31 focusing the radiation reflected by the slide on the sensitive surface of the detector. It can be used to collect an image of absorption by the chip at the wavelength of interest, by relative lateral displacement of the biochip with respect to the focusing axis 40 of the optical radiation so as to scan the surface of the biochip.

The detection device may comprise a single transducer strip (photodiodes). This is enough to collect the entire image of a DNA chip, by scanning, considering its normal dimensions (of the order of a few square centimetres). It may also include a transducer matrix (with two dimensions). The advantage of using a scanning matrix is to limit the effects of defective pixels, to benefit from statistical processing on several columns (binning) and to make a hyper-spectral image if optical dispersion is used. A matrix can also be used to image a chip with no displacement but with a resolution limited by the number of its pixels.

In practice, the wavelength of interest λᵢ is 260 nanometres for DNA chips, corresponding to the maximum absorption of nitrogen bases. The wavelength of interest λᵢ for protein chips is 280 nanometres. At least one of the illumination and detection devices must be selective about the wavelength of interest of the biochip, either intrinsically or by means of a very selective filter. An ultraviolet lighting source selective at 260 nanometres, which is the maximum absorption of nitrogen bases, could thus be used. The source will then typically be a laser source or a light emitting diode, possibly associated with a filter. A white source (Xenon or Deuterium lamp) associated with a monochromator could also be used.

The detection device 30 is preferably a semiconducting detector with a narrow spectral band around the wavelength of interest λᵢ. Such a detector comprises an active layer on a filtering window layer. Filtering is naturally done by the window layer for wavelengths shorter than 260 nm and by the prohibited band of the active layer for longer wavelengths. These detectors thus give a strong response in the 260-290 nanometre ultraviolet band, while rejecting their response on each side of this band by several orders of magnitude. In particular, AlGaN bandgap detectors sensitive in the 260-280 nanometre range are particularly suitable for an imagery device according to the invention. The response of such a detector is shown on the curve in FIG. 5. The curve connecting black rectangle points represents the response obtained with front side illumination and the curve connecting the circles represents the response with back side illumination. The ordinate represents the detector response, and the abscissa the wavelength in micrometers.

One advantageous configuration then comprise a white source to illuminate the biochip and a narrow band detector illuminated by the back face through the window layer. In this way, there is no need for a filter specific to the light source, because the detector operates in a narrow spectral band. This solution is advantageous because powerful UV sources and passband filters are expensive and undesirable wavelengths are rejected at the detriment of the transmission at the wavelength of interest. By using an AlGaN bandgap detector, an off-the-shelf wide band illumination source without a filter can be used in the detection device, while benefiting from a large detection sensitivity.

In one variant shown in FIG. 2, the imagery device uses several wavelengths of interest, λᵢ and λⱼ in the example illustrated, for the purposes of spectral dispersion functions, around the absorption maxima. Such functions are interesting for spectral identification purposes, particularly in the case of protein chips. The detection device will then be a matrix if it is required to simultaneously measure absorption contrasts at different wavelengths. The use of a strip would make it necessary to reposition the optical device for each studied wavelength.

The imagery device then comprises an illumination source 50 and a detection device 51 covering a spectral range comprising at least the wavelengths of interest.

In a practical example, the emission spectrum of the source 50 corresponds to the 240-290 nanometre UV B band, and the detector has a spectral sensitivity in this range.

The imagery device is then designed to measure the response of the chip 10 at at least two wavelengths of interest located in the ultraviolet B band, typically 240-290 nanometres. This is equally applicable to DNA chips and to protein chips. An illumination source and a corresponding detection device are then provided. Thus, as shown in FIG. 2, the illumination source will have at least one corresponding emission spectrum, in other words in the 240-290 nanometre UV B band, and a detector sensitive in this range.

The illumination source 50 will then preferably be a wide band radiation or white source, typically a Xenon or Deuterium lamp.

The detection device 51 may be a conventional off-the-shelf scanner, in other words an ultraviolet B band [240-290] nanometre radiation detector.

Preferably, the detection device 51 is a semiconducting detector with a narrow spectral band, particularly of the AlGaN type with high sensitivity in the biochip spectral response range, and as mentioned above, is capable of working in a narrow spectral band when it is illuminated through its back face, even when the biochip is illuminated using an off-the-shelf white source.

The detection side of the imagery device shown in FIG. 2 then comprises a collimation optic 52, a dispersion optic 53, and an optic 54 focusing the reflected beam used to collect images differentiated in wavelength.

The collimation optic 52 is preferably reflective so that it is not adversely affected by the index dispersion present from 240 to 290 nm. In a low cost imagery device, this will be done by lenses. For example, the dispersion optic 53 comprises a prism or a diffraction grating. The collimation optic 52 and the focusing optic 54 are each made conventionally using a lens. All these optical elements are well known to those skilled in the art of detection of light beams.

The two devices represented in FIGS. 1 and 2 operate in reflection. The surface 11 of the support on which the spots are located has the highest possible reflection coefficient. Only a few tens of percent are necessary. For example, the angle of incidence of the beam emitted by the source on the surface 11 may be of the order of 45 degrees.

The device can operate in transmission. A “transmissive” variant of the reflective device in FIG. 1 is shown in FIG. 3. The support must then have a sufficient transmission coefficient of the order of at least 10 percent. It may be molten silica, CaF₂, sapphire, PDMS (Polydimethyl siloxane) up to 260 nm. The detector 31 can then be placed in direct contact with the back of the support. However, the use of a focusing optic 32 provides a means of optimising the transmitted flux collection and keeping the surface of the detector clean.

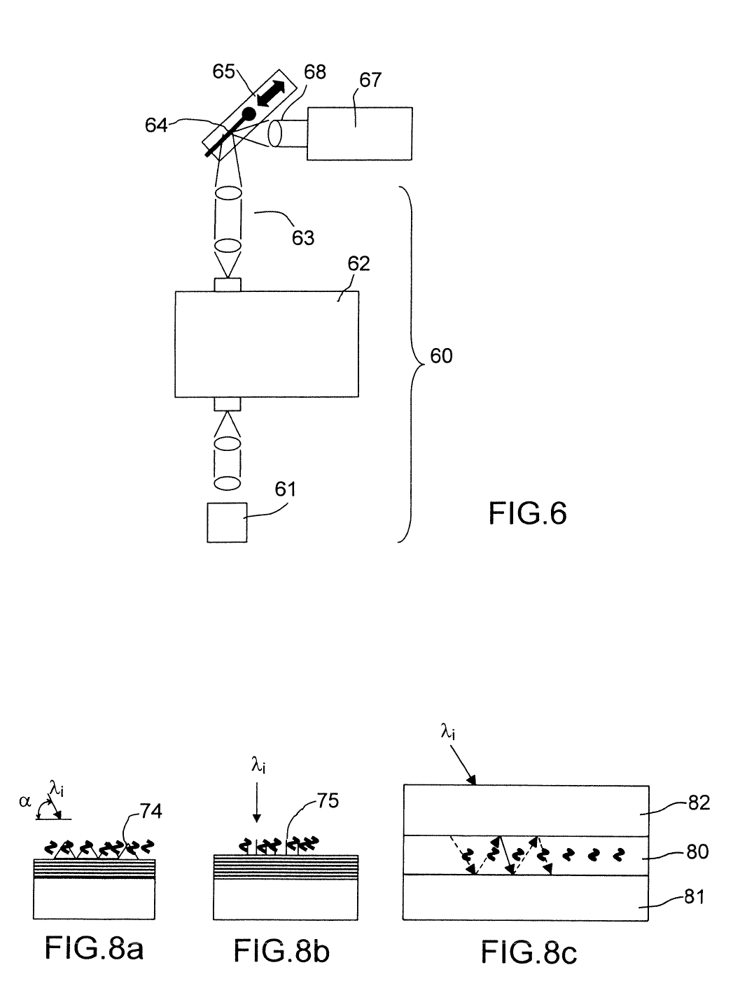

An imagery device according to the invention was made, for which the configuration is shown in detail in FIG. 6. The source 60 comprises a xenon lamp 61 followed by a monochromator 62 which only allows the wavelength of interest λᵢ (or a window including the wavelengths of interest) to pass at the output, and the focusing optic 63.

The biochip 65 is mounted on an element 66 used to translate it in the plane relative to a focusing axis 64 of the source 60. Thus, the entire slide can be scanned by the emission beam over its entire length.

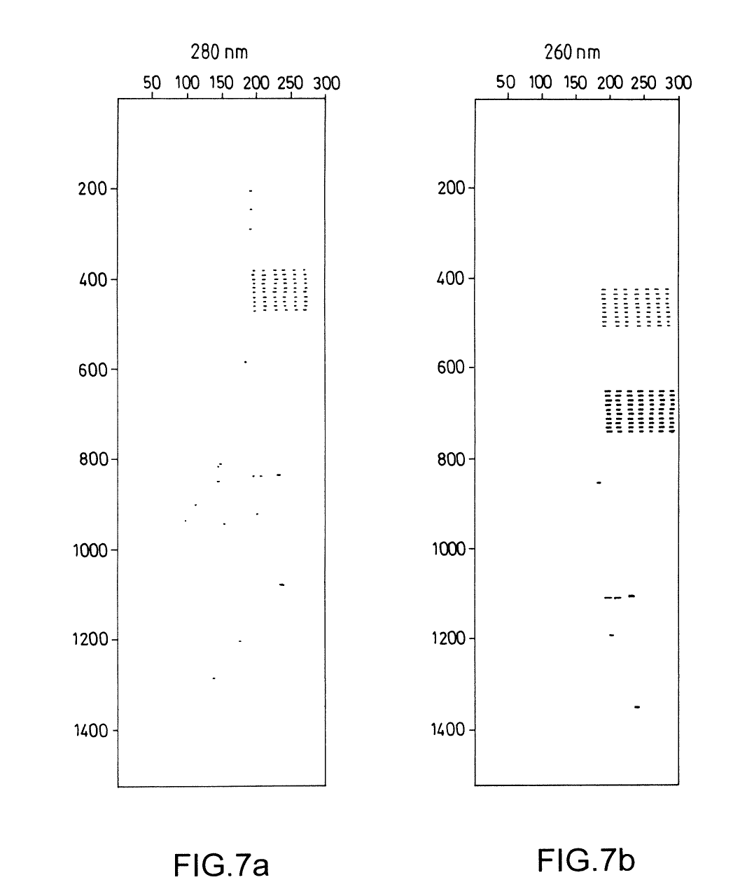

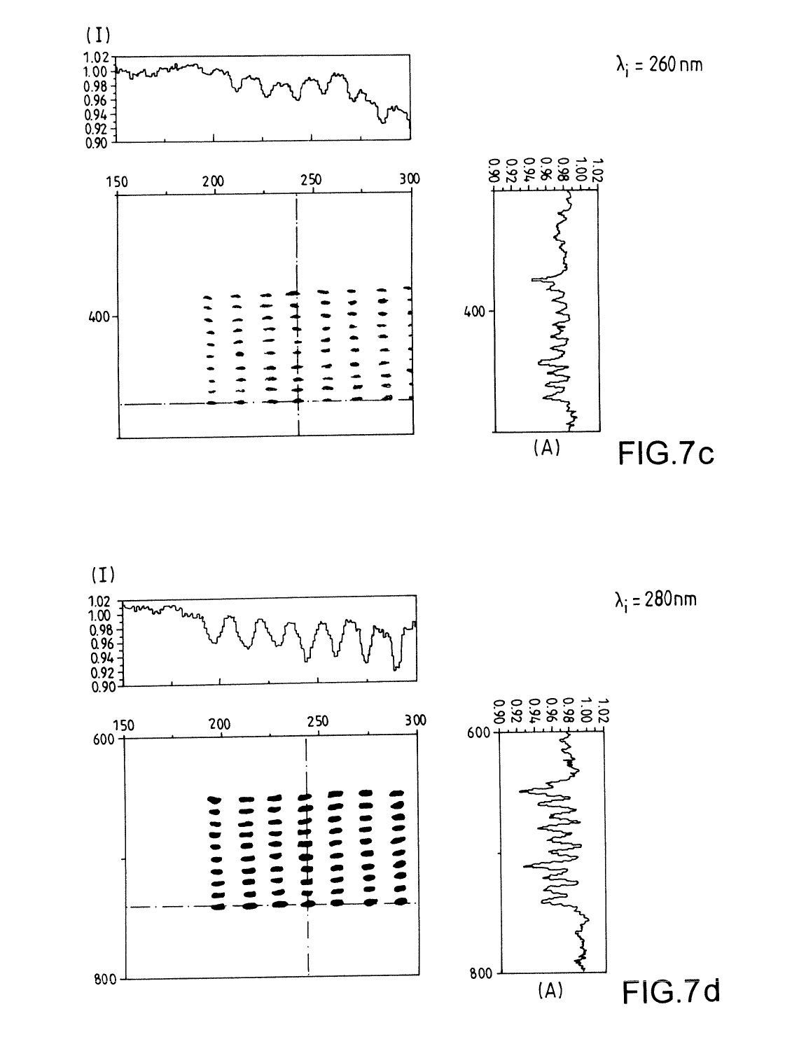

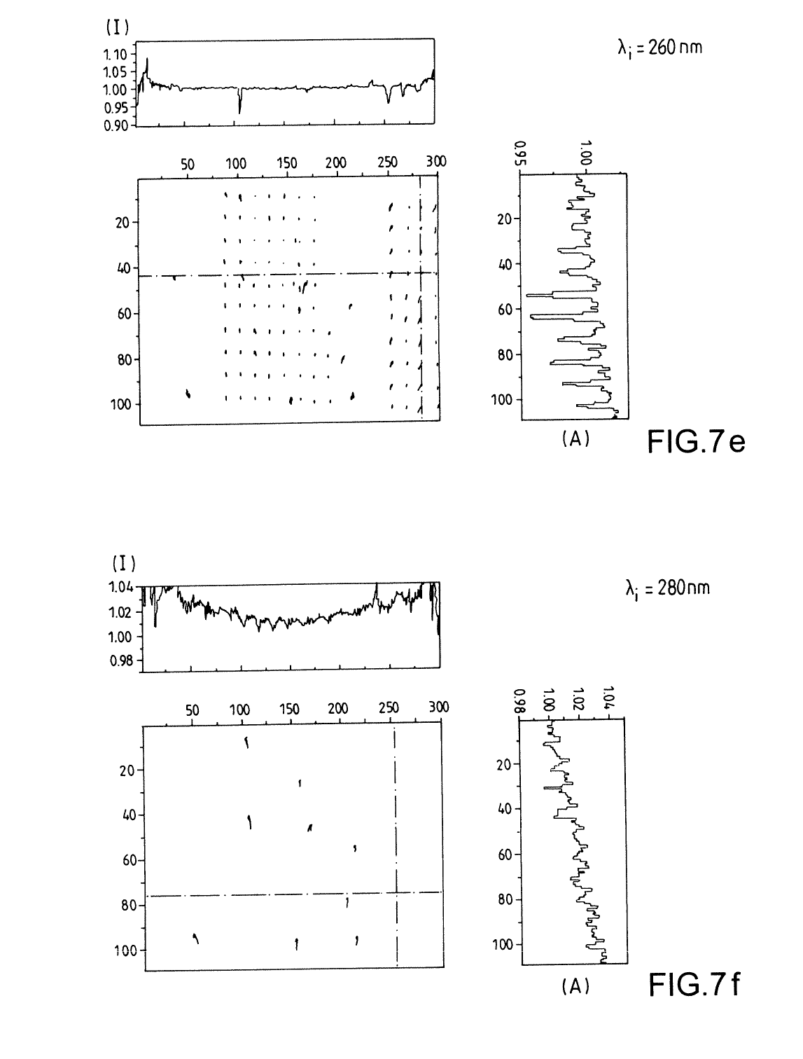

The semiconducting detector 67 is of the AlGaN type with a narrow spectral band, comprising a strip with several hundred pixels, and comprises an associated focusing optic 68, in other words a lens. In practice, the biochip is a DNA chip for which the support is a glass slide for which the upper face has a coefficient of reflection of 30% at 260 nanometres. DNA strands immobilised on the spots are 500 bases to 5000 bases long. Spot sizes are of the order of 300 micrometers. The lens 68 making the image on the strip can produce an image with no magnification. For a 300 pixels and 26 micrometer wide strip, the width of the zone scanned on the slide is 8 millimetres. Each spot is thus likely to appear on about 10 pixels with a satisfactory resolution. The images shown in FIGS. 7a and 7b were produced using illuminations at 260 nanometres and 280 nanometres, on an oligonucleotide biochip, for which the length of the strands is 70 bases. In these black and white images, the colour range corresponds to a contrast varying from 0.95 to 1.05. The spots can be observed at two wavelengths but the contrast is much better at 260 nanometres. In particular, for spots with the highest contrast, absorption at λᵢ=280 nm is 3% and absorption at λᵢ=260 nm is 5%.

The images shown in FIGS. 7c and 7d result from the analysis of spots with higher contrasts on the images in FIGS. 7a and 7b. They show that absorption at 260 nm (FIG. 7d) and 280 nm (FIG. 7c) may be estimated at 5 and 2 percent. The images in FIGS. 7e and 7f are produced with a biochip, with single DNA strands between 500 to 5000 bases long. The first image (FIG. 7e) is for illumination at λᵢ=260 nm, and the second image (FIG. 7f) is for illumination at λᵢ=280 nm. The contrast range on these images varies from 0.94 to 1.1. Observed spot absorption is of the order of 4 to 5% at 260 nm.

In these images, the DNA biochip is shown such that the length is given by the vertical and the width by the horizontal. Conventionally, the spots are arranged in rows (horizontal) or columns (vertical). The slide is scanned from top to bottom by the illumination source. The profile of interest along a horizontal line h plotted on the image is shown in FIGS. 7e and 7f as reference 1. The absorption profile along a column of spots is given on the images as reference A.

These images confirm that the origin of the contrast obtained is actually the intrinsic absorption of the bases of biochemical elements, and not parasite roughness effects such as dust. The absorption of spots at 280 nanometres is practically concealed by noise at this wavelength and does not exceed 1%. In practice, using the image obtained with different illuminations varying from 260 to 280 nm, it has been checked that dust appears on all images with the same absorption contrast.

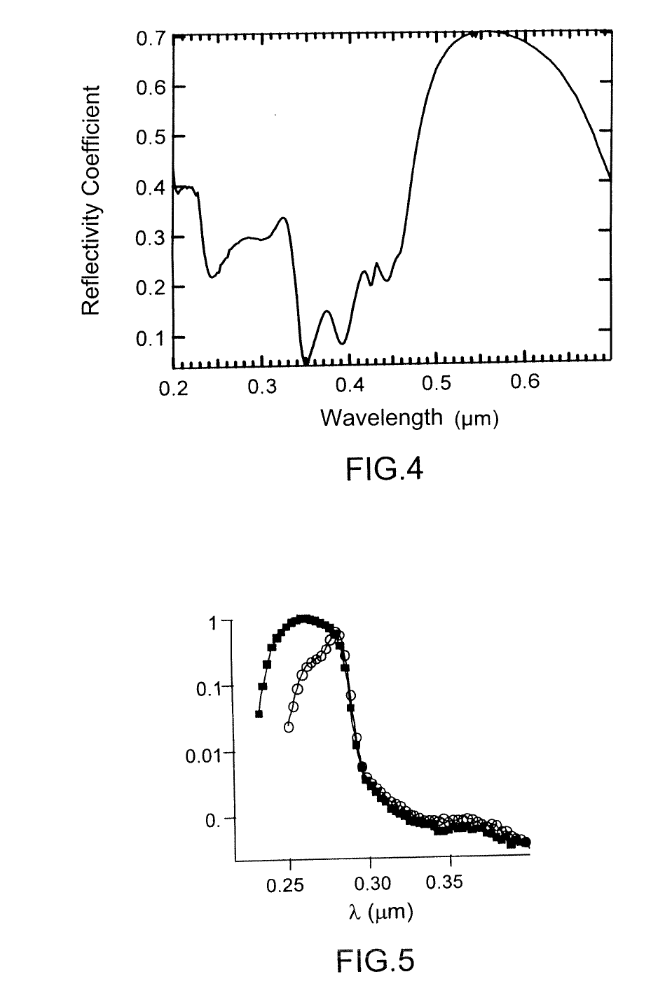

FIG. 4 shows the optical properties of a biochip support of the reflective type used in the invention. This support comprises a substrate on which a multilayer structure of materials is produced, so as to form a mirror with a non-negligible reflection coefficient within the range of wavelengths around the wavelength of interest, namely typically about 260 nanometres in the case of biochips of the DNA chip type, and 280 nanometres in the case of biochips of the protein chip type.

In one example, the reflection coefficient may be improved by means of a dielectric multilayer (titanium and aluminium oxide) or a metallic deposit. Reflectivity may be adjusted as a function of the wavelength of interest (260 or 280 nm) by adjusting the thicknesses and the nature of the dielectric multilayer covering the support. A support comprising a metallic layer with strong reflection at 260 nm, covered by a dielectric protection layer on which the spots are arranged, is suitable for the application and can prove to be more economic.

In one improvement of the invention, an imagery system according to the invention uses a biochip for which the texture on the upper face 11 is such that the absorption signal generated by the biochemical elements immobilised on the spots is amplified. The response of the system is improved.

According to a first embodiment of an improved biochip, particularly suitable for an imagery system according to the invention, the biochip surface is made to be very rough, even if this means making it slightly porous over a thickness of a few tens to a few hundreds of nanometres. This thus increases the effective grafting surface. The density of biochemical elements immobilised on each spot is increased, and absorption is thus amplified.

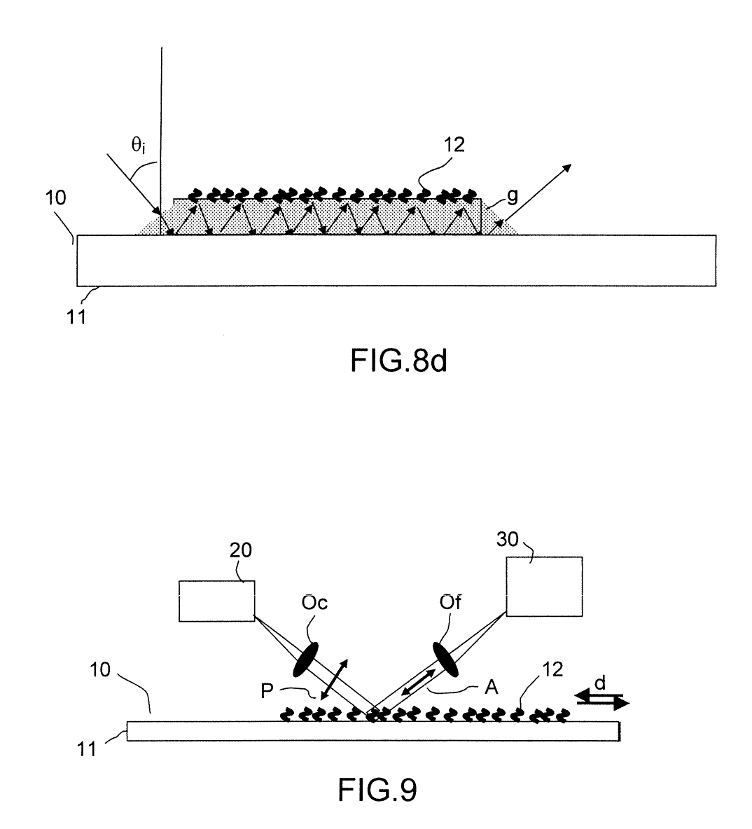

According to another embodiment shown in FIGS. 8a and 8b, the upper face 71 comprises protuberant geometric patterns. Their effect is to increase the density of biochemical elements immobilised on each spot. Reconsidering the example of the DNA chip, this mean is used to increase the number of strands on each spot. This is equivalent to increasing the thickness of the biochemical element and therefore to increasing the optical path through which the incident beam passes. This thus increases absorption.

The upper face 71 of the support 70 thus comprises patterns on which the spots are arranged. These patterns are protuberant geometric patterns, with at least one inclined plane 74 (FIG. 8a) or vertical plane 75 (FIG. 8b) relative to the support surface. The chemical elements 76 are immobilised on this plane. The angle of incidence α of the illumination with the support surface is chosen to correspond to the angle formed by the plane supporting the spots with the surface, for example 45 degrees for inclined planes 74, 90 degrees for vertical planes 75. Consequently, the density of chemical elements on each spot is increased and the angle of incidence of the illumination is chosen to reach all these chemical elements. The absorption signal of each spot is increased.

In another embodiment shown in FIG. 8c, these patterns are such that they encourage reflections of the incident beam, such that the absorption signal is amplified.

In the example shown, the support comprises a porous layer 80 trapping biochemical elements to be immobilised on the spots. For example, it may be a molten silica layer, partially acid etched, so as to form porosities (pits). A spot may cover a wide porous area. Biochemical elements are then immobilised in this layer. Two layers 81 and 82 are located on each side of this layer, at least one of which is also porous. In the example, layer 82 is located on layer 80 and is porous. It allows biochemical elements of samples to be analysed to pass through. These layers 81 and 82 on each side have a face reflecting towards the first porous layer 80.

The illumination beam thus passes through the layers 82 and 80, and is subjected to multiple reflections in layer 81 due to reflecting walls of layers 82 and 81. The optical path is thus lengthened due to the reflection effect in the layer 80, thus amplifying the absorption signal in the biochemical elements.

A waveguide g with a high index n' could also be provided between the surface of the support slide 11 and the DNA spots 12, as shown in FIG. 8d, to encourage a light multi-pass effect, obtained by total internal reflection inside the waveguide g. Total internal reflection is obtained when the angle of incidence θᵢ of the light emitted by the source onto the surfaces of the waveguide g is such that it retains it, in a known manner. A necessary condition is that the outside environment must have a lower index than the guide. For example, this is the case for air (n˜1) or water (n˜1.33). The wave cannot then be transmitted into the medium with a lower index, without respecting Snell-Descartes' law. Total internal reflection also takes place at the interface between the optic guide and the substrate, if the index of the substrate is lower than the index of the guide. Multi-passes of light in the waveguide amplify the absorption signal. For each reflection on the upper wall of the guide, there is absorption of the evanescent waves present outside the guide by DNA spots, and this absorption can increase with successive reflections.

Multi-passes can also amplify a dichroism effect which improves the contrast. This dichroism effect is related to the use of light polarisation. By illuminating a support slide 11 covered with DNA spots 12 (biochip 10) using polarised light, dichroism of the biological material is significantly marked in ultraviolet, thus increasing the contrast between areas covered by DNA and the rest of the surface of the support slide. A polarizer for incident light and an analyser for reflected light can make use of this dichroism.

Thus, it is possible to advantageously benefit from polarisation of light to improve detection by increasing the contrast between areas covered with DNA and the rest of the surface of the support slide.

We will briefly summarize the different light polarisation states before and after reflections on a surface, with reference to FIG. 13; transverse electrical polarisation TE is the term used for the configuration in which the electrical component of the electromagnetic wave is polarised perpendicular to the plane of incidence (the plane containing incident and reflected radiation). The component of the associated magnetic field is then in this plane of incidence. Conversely, transverse magnetic polarisation TM is the term used to refer to the configuration in which the magnetic field is perpendicular to the plane of incidence and the component of the electric field is in the plane of incidence. The values θᵢ, θₜ, θᵣ are the angles of incidence, reflection and refraction, n is the index of the support slide 11, where n is not equal to 1, and N is the direction of the normal to the surface of the slide.

The reflection and transmission coefficients are defined for each polarisation and depend on the angle. In illuminating a lamp covered with DNA spots with polarised light, the dichroism of the biological material, particularly marked in ultraviolet increases the contrast between the areas covered with DNA and the rest of the slide. A polarizer P for incident light and an analyser A for reflected light are used to exploit this dichroism as shown in FIG. 9. In a practical example embodiment, a collimation optic Oc and a polarizer P are located on the path of the incident beam between the source and the surface of the support slide; and a focusing optic Of and an analyser A are located on the path of the beam reflected by the surface of the support slide 11 towards the detection device (FIG. 9). The support slide 10 is displaced (d) relative to the optical focusing axis, to cover the entire surface.

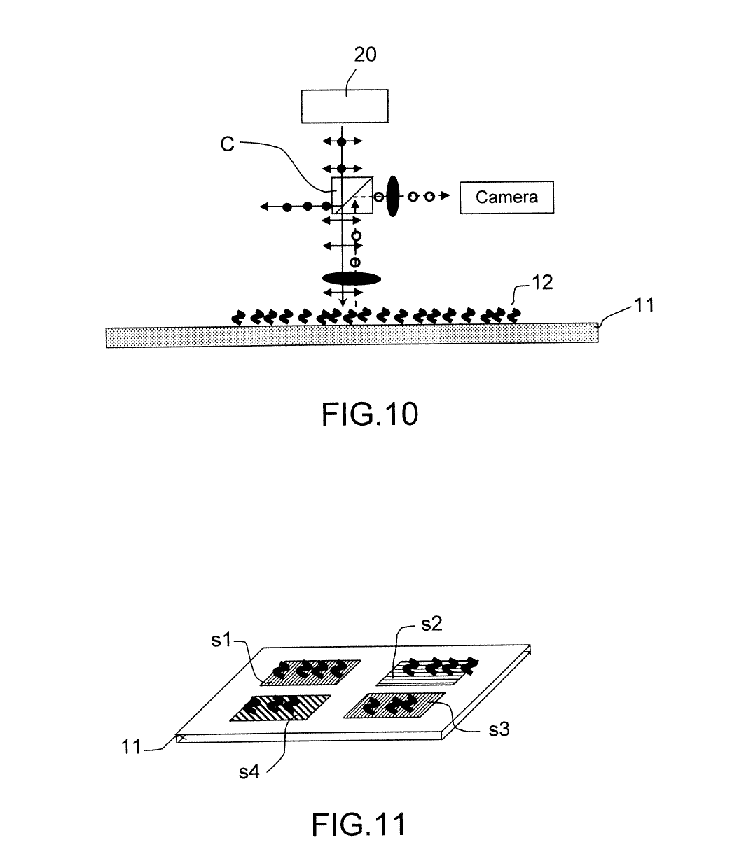

In a variant shown in FIG. 10, a polarising separation device C is used in normal incidence. Arrows are used on the figure to denote polarisation in the plane of the sheet, and dots are used to denote perpendicular polarisation. The device C thus allows a single polarisation to pass towards the surface of the support slide, the other polarisation being directed in another direction. The reflected polarisation represented by circles is sent to the camera. The device is capable of illuminating the slide with a single polarisation, and sends the reflected polarisation towards a camera on which dichroism is thus directly displayed. This polarising separation device C may be a conventional polarised beam separation device, for example a Glan-Taylor prisms polarizer. In the two cases shown in FIG. 9 and FIG. 10, Stokes-Mueller's formal description can be used to describe the variation of polarisation of light during the transmission and reflection of light on the DNA spot support slide. Remember that Mueller's matrix is an order 4 matrix applied to Stokes vector composed of 4 elements:

Intensity: I=<EₓEₓ*+E_{y}E_{y}*>

Linear polarisation: I=<EₓEₓ*−E_{y}E_{y}*>

Polarisation at 45°: U=<EₓE_{y}*+E_{y}Eₓ*>

Straight circular polarisation: V=<EₓE_{y}*−E_{y}Eₓ*>

In one improvement, straight parallel structures s1, s2, s3, s4 are made on the surface of the support slide 11, similar to the diffraction gratings shown in the examples in FIG. 11. These structures are used to obtain a better coefficient of reflection for given polarisations, depending on the structure direction. Thus a given reflection polarisation, and particularly a circular polarisation can be facilitated. As shown, several different structures can be provided (different straight orientations) on this support slide 10, which facilitates differential detections.

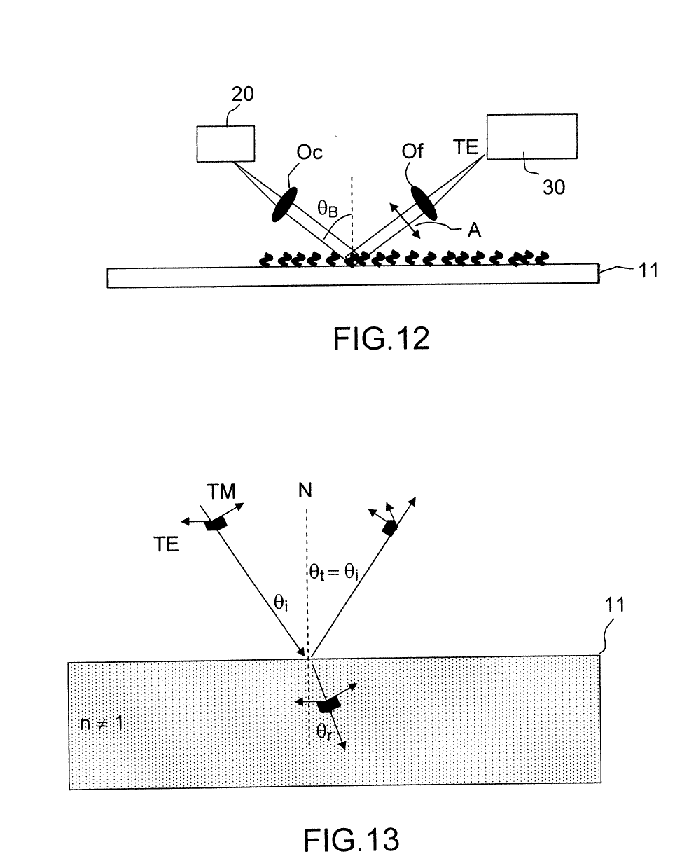

One advantageous use of the polarisation of light is to eliminate the polarizer P used on the imagery system shown in FIG. 9, as shown in FIG. 12. In this application, the Brewster θ_{B} angle is used as the angle of incidence θᵢ of ultraviolet illumination emitted by the source. The Brewster θ_{B} angle is the angle at which the reflection of TM polarisation cancels out and therefore reflected light is exclusively in TE polarisation. In this application, dichroism of the biological material that is particularly marked in ultraviolet results in a stronger TM polarisation for areas on the surface of the support slide 11 covered with DNA.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. Imagery system for biochemical elements comprising a biochip comprising an approximately plane support, with a plurality of spots on an upper face, on which biochemical elements to be analysed are arranged, a light beam source to illuminate said upper face of the biochip and a device for detection of radiation emitted by said upper face, wherein the source and the detection device each function in a wavelength band comprising a spectral band covering at least a determined wavelength on interest within the ultraviolet radiation band, in that at least the source or the detection device is selective in said spectral band and in that the support of said biochip has reflectivity or transmission coefficient in said spectral band such that the system will operate in reflection or in transmission.

2. System according to claim 1, wherein the source and/or the detection device function in a window with a wavelength inside or equal to a 240-290 nanometres band.

3. System according to claim 2, wherein said detection device is a semiconducting device with a narrow spectral band.

4. System according to claim 3, wherein the source is a white light source arranged to illuminate the chip from the back face of said detection device.

5. System according to claim 2, wherein the source is a white source associated with a selection filter centred on said wavelength of interest.

6. System according to claim 1, wherein the upper face of the biochip has a texture such that the absorption signal generated by the biochemical elements immobilised on the spots is amplified.

7. System according to claim 6, wherein the upper face of the biochip has a rough surface making it possible to increase the visible surface of the biochip.

8. System according to claim 6, wherein the upper face of the biochip comprises patterns on which spots are arranged, said patterns being such that the optical path of the light beam through the biochemical elements is lengthened.

9. System according to claim 8, wherein said patterns are protuberant geometric patterns, such that the density of biochemical elements on each spot is increased.

10. System according to claim 9, wherein said patterns comprise an inclined or vertical plane onto which said biochemical elements are grafted, and the light beam has an incidence angle on the surface of the biochip corresponding to the angle formed by said plane of the patterns with said surface.

11. System according to claim 8, wherein said patterns are porosities, the support comprising at least three layers, a first porous layer for which the porosities form spots on which biochemical elements are immobilised, and a layer on each side, at least one of which is also porous so as to make hybridization possible, said layers on each side having a reflecting face towards said first porous, such that the optical path is enhanced by the reflection effect in said first porous layer.

12. System according to claim 1, wherein a waveguide is provided on the surface of the support of the biochip, the spots of biochemical elements being deposited on the upper face of the waveguide, said waveguide enabling multi-passes of light in the waveguide.

13. System according to claim 1, comprising means of polarising light to increase the contrast between zones of the support comprising biochemical elements and zones with no biochemical elements.

14. System according to claim 13, wherein said support comprises one or more gratings in the form of straight parallel structures on its upper face, on which spots of biochemical elements are deposited, each grating facilitating a given reflection polarisation, depending on the direction of the corresponding straight structure.

15. System according to claim 1, wherein a lower limit of the reflectivity or transmission coefficient at said wavelength of interest is of the order of 10 percent.
